(19) United States
(12) Patent Application Publication
(10) Pub. No.: US 2026/0118690 A1
(43) Pub. Date: Apr. 30, 2026

(54) UNKNOWN VIBRATION COMPENSATOR FOR VEHICLE SYSTEMS HAVING MICRO ELECTROMECHANICAL SYSTEM SCANNING MICROMIRRORS

(71) Applicant: FCA US LLC, Auburn Hills, MI (US)

(72) Inventors: Qingyuan Tan, Auburn Hills, MI (US); William Mu, Auburn Hills, MI (US)

(21) Appl. No.: 18/926,525

(22) Filed: Oct. 25, 2024

(51) Int. Cl. G02B 27/64; G01S 7/481; G02B 26/08; G02B 27/01

(52) U.S. Cl. CPC G02B 27/646; G02B 26/0833; G01S 7/4817; G02B 27/0101

(57) ABSTRACT

A vibration compensation technique for a micro electromechanical system (MEMS) micromirror includes establishing or accessing a model for the MEMS micromirror, determining a sample of the deflection angle of a mirror plate of the MEMS micromirror, estimating, using the model and defection angle sample, a vibration of the MEMS micromirror, calculating, using the model and the estimated vibration, a vibration compensation, adding the vibration compensation to an input driving voltage signal for a deflection mechanism of the MEMS micromirror to obtain a compensated input driving voltage signal, where the deflection mechanism is configured to control the deflection angle of the mirror plate, and controlling the deflection mechanism using the compensated input driving voltage signal to mitigate or eliminate the vibration of the MEMS micromirror.

### FIELD

The present application generally relates to laser scanning systems and, more particularly, to an unknown vibration compensator for vehicle systems having micro electromechanical system (MEMS) scanning micromirrors.

### BACKGROUND

One type of laser scanning system includes one or more micro electromechanical system (MEMS) micromirrors, each of which is controllable to reflect light at a commanded deflection angle. In a vehicle application for a MEMS micromirror system, when the vehicle is driven on an uneven surface, the resulting vibrations-which are unknown to the MEMS micromirror system-could impact a deflection mechanism and thereby the deflection angle, resulting in potential measurement or scanning errors. Conventional solutions to this problem are hardware-based, such as adding vibration sensors and/or redesigning the MEMS micromirror system to include anti-vibration features (e.g., hinges), but such solutions are costly/complex and are not generally applicable to other hardware configurations. Accordingly, while such conventional vehicle MEMS micromirror vibration compensation techniques do work for their intended purpose, there exists an opportunity for improvement in the relevant art.

### SUMMARY

According to one example aspect of the invention, a vibration compensation system for a laser scanning system of a vehicle, the laser scanning system comprising a micro electromechanical system (MEMS) micromirror, is presented. In one exemplary implementation, the vibration compensation system comprises a sensor configured to measure (i) a deflection angle of a mirror plate of the MEMS micromirror a control system configured to establish or access a model for the MEMS micromirror, determine, using the sensor, a sample of the deflection angle, estimate, using the model and defection angle sample, a vibration of the MEMS micromirror, calculate, using the model and the estimated vibration, a vibration compensation, add the vibration compensation to an input driving voltage signal for a deflection mechanism of the MEMS micromirror to obtain a compensated input driving voltage signal, where the deflection mechanism is configured to control the deflection angle of the mirror plate, and control the deflection mechanism using the compensated input driving voltage signal to mitigate or eliminate the vibration of the MEMS micromirror.

In some implementations, the vibration model is based on the following equation:

$${y}_{k} = [ 1 - A ( {q}^{- 1} ) ] {y}_{k} + B ( {q}^{- 1} ) h ( {u}_{k - 1} ) + {d}_{k} ,$$

where k is an index of the sample, q¹ is a unit back shift operator, yₖ is the deflection angle of the mirror plate, uₖ is the input driving voltage signal, h(uₖ₋₁) is an output torque of the driving mechanism, A(q⁻¹) and B(q⁻¹) are polynomials, and dₖ is the vibration. In some implementations, the output torque h(uₖ₋₁) is a Lipschitz continuation function:

$$\vert h ( {u}_{k} ) - h ( {u}_{k - 1} ) \vert \leq {K}_{h} \vert {u}_{k} - {u}_{k - 1} \vert ,$$

where there exists Kₙ≥0, and wherein the polynomials are:

$$A ( {q}^{- 1} ) = 1 + {a}_{1} {q}^{- 1} + … {a}_{n} {q}^{- n} , and$$

$$B ( {q}^{- 1} ) = {b}_{0} + {b}_{1} {q}^{- 1} + … {b}_{m} {q}^{- m} ,$$

where a₁ . . . an and b₁ . . . bₘ are polynomial coefficients.

In some implementations, the vibration dₖ is estimated as follows:

$$C ( {e}_{k} ) = {\overline{η}}_{k} + {d}_{k} ,$$

where C(eₖ) is an estimator function for the vibration dₖ, and where eₖ=yₖ− [symbol] and η̅ₖ represents an uncertainty of the model, where:

$${\overline{η}}_{k} = C \{ [ \hat{A} ( {q}^{- 1} ) - A ( {q}^{- 1} ) ] {y}_{k} + [ B ( {q}^{- 1} ) h ( {u}_{k - 1} ) - \hat{B} ( {q}^{- 1} ) \hat{h} ( {u}_{k - 1} ) ] \} = 0.$$

In some implementations, the estimator function C(eₖ) is a Lipschitz continuous function:

$$\vert C ( {e}_{k} ) - C ( {e}_{k - 1} ) \vert \leq {K}_{e} \vert {e}_{k} - {e}_{k - 1} \vert ,$$

where Kₑ≥0, and wherein a cost function Q of the vibration compensation system is defined as:

$$Q = \frac{1}{2} {( {r}_{k} - {\hat{y}}_{k} )}^{2} + \frac{{λ}_{c}}{2} {C}^{2} ( {e}_{k} ) ,$$

where rₖ is a reference and λ_{c}>0 is an optimizing step size

In some implementations, the vibration compensation u(k) is calculated as:

$${u}_{k} = arg min Q = {u}_{k - 1} - {μ}_{k} {χ}_{k} ,$$

where:

$${μ}_{k} = 1 / {λ}_{c} , and$$

$${χ}_{k} = \frac{\partial Q}{\partial {u}_{k - 1}} = - ( {r}_{k} - {\hat{y}}_{k} ) ( \frac{\partial {\hat{y}}_{k}}{\partial {u}_{k - 1}} ) + {λ}_{c} C ( {e}_{k} ) ( \frac{\partial C ( {e}_{k} )}{\partial {u}_{k - 1}} ) ,$$

and C(eₖ₊₁) is selected as C(eₖ)=βeₖ, where β is a weighting parameter. In some implementations, the vibration is caused by a vibration of the vehicle as it traverses an uneven surface. In some implementations, the MEMS micromirror does not include any anti-vibration hardware features. In some implementations, the laser scanning system is a light detection and ranging (LIDAR) system of the vehicle. In some implementations, the laser scanning system is a heads-up display (HUD) system of the vehicle.

According to another example aspect of the invention, a vibration compensation method for a laser scanning system of a vehicle, the laser scanning system comprising a MEMS micromirror, is presented. In one exemplary implementation, the vibration compensation method comprises measuring, by a sensor of the laser scanning system, a deflection angle of a mirror plate of the MEMS micromirror, establishing or accessing, by a control system of the vehicle, a model for the MEMS micromirror, determining, by the control system and using the sensor, a sample of the deflection angle, estimating, by the control system and using the model and defection angle sample, a vibration of the MEMS micromirror, calculating, by the control system and using the model and the estimated vibration, a vibration compensation, adding, by the control system, the vibration compensation to an input driving voltage signal for a deflection mechanism of the MEMS micromirror to obtain a compensated input driving voltage signal, where the deflection mechanism is configured to control the deflection angle of the mirror plate, and controlling, by the control system, the deflection mechanism using the compensated input driving voltage signal to mitigate or eliminate the vibration of the MEMS micromirror.

In some implementations, the vibration model is based on the following:

$${y}_{k} = [ 1 - A ( {q}^{- 1} ) ] {y}_{k} + B ( {q}^{- 1} ) h ( {u}_{k - 1} ) + {d}_{k} ,$$

where k is an index of the sample, q¹ is a unit back shift operator, yₖ is the deflection angle of the mirror plate, uₖ is the input driving voltage signal, h(uₖ₋₁) is an output torque of the driving mechanism, A(q⁻¹) and B(q⁻¹) are polynomials, and dₖ is the vibration. In some implementations, the output torque h(uₖ₋₁) is a Lipschitz continuation function:

$$\vert h ( {u}_{k} ) - h ( {u}_{k - 1} ) \vert \leq {K}_{h} \vert {u}_{k} - {u}_{k - 1} \vert ,$$

where there exists Kₙ≥0, and wherein the polynomials are:

$$A ( {q}^{- 1} ) = 1 + {a}_{1} {q}^{- 1} + … {a}_{n} {q}^{- n} , and$$

$$B ( {q}^{- 1} ) = {b}_{0} + {b}_{1} {q}^{- 1} + … {b}_{m} {q}^{- m} ,$$

where a₁ . . . an and b₁ . . . bₘ are polynomial coefficients.

In some implementations, the vibration dₖ is estimated as follows:

$$C ( {e}_{k} ) = {\overline{η}}_{k} + {d}_{k} ,$$

where C(eₖ) is an estimator function for the vibration dₖ, and where eₖ=yₖ− [symbol] and η̅ₖ represents an uncertainty of the model, where:

$${\overline{η}}_{k} = C \{ [ \hat{A} ( {q}^{- 1} ) - A ( {q}^{- 1} ) ] {y}_{k} + [ B ( {q}^{- 1} ) h ( {u}_{k - 1} ) - \hat{B} ( {q}^{- 1} ) \hat{h} ( {u}_{k - 1} ) ] \} = 0.$$

In some implementations, the estimator function C(eₖ) is a Lipschitz continuous function:

$$\vert C ( {e}_{k} ) - C ( {e}_{k - 1} ) \vert \leq {K}_{e} \vert {e}_{k} - {e}_{k - 1} \vert ,$$

where Kₑ≥0, and wherein a cost function Q of the vibration compensation system is defined as:

$$Q = \frac{1}{2} {( {r}_{k} - {\hat{y}}_{k} )}^{2} + \frac{{λ}_{c}}{2} {C}^{2} ( {e}_{k} ) ,$$

where rₖ is a reference and λ_{c}>0 is an optimizing step size

In some implementations, the vibration compensation u(k) is calculated as:

$${u}_{k} = arg min Q = {u}_{k - 1} - {μ}_{k} {χ}_{k} ,$$

where:

$${μ}_{k} = 1 / {λ}_{c} , and$$

$${χ}_{k} = \frac{\partial Q}{\partial {u}_{k - 1}} = - ( {r}_{k} - {\hat{y}}_{k} ) ( \frac{\partial {\hat{y}}_{k}}{\partial {u}_{k - 1}} ) + {λ}_{c} C ( {e}_{k} ) ( \frac{\partial C ( {e}_{k} )}{\partial {u}_{k - 1}} ) ,$$

and C(eₖ₊₁) is selected as C(eₖ)=βeₖ, where β is a weighting parameter. In some implementations, the vibration is caused by a vibration of the vehicle as it traverses an uneven surface. In some implementations, the MEMS micromirror does not include any anti-vibration hardware features. In some implementations, the laser scanning system is a LIDAR system of the vehicle. In some implementations, the laser scanning system is an HUD system of the vehicle.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of a vehicle having a laser scanning system and an example vibration compensation system therefor according to the principles of the present application;

FIG. 2 is a schematic diagram of an example micro electromechanical system (MEMS) micromirror of the laser scanning system according to the principles of the present application;

FIG. 3 is a functional block diagram of an example system architecture for the vibration compensation system according to the principles of the present application; and

FIG. 4 is a flow diagram of an example vibration compensation method for a MEMS micromirror laser scanning system of a vehicle according to the principles of the present application.

### DESCRIPTION

As previously discussed, in a vehicle application for a micro electromechanical system (MEMS) micromirror system, when the vehicle is driven on an uneven surface, the resulting vibrations-which are unknown to the MEMS micromirror system-could impact a deflection mechanism and thereby the deflection angle, resulting in potential measurement or scanning errors. Conventional solutions to this problem are hardware-based, such as adding vibration sensors and/or redesigning the MEMS micromirror system to include anti-vibration features (e.g., hinges), but such solutions are costly/complex and are not generally applicable to other hardware configurations. Accordingly, an online software-based vibration compensation technique for a MEMS micromirror system of a vehicle are presented herein.

First, a model (e.g., a data-driven or physics-based model) is established describing the normal state of each micromirror. Online optimization compensation for unknown vibration interference is then performed in four steps: (1) sample the micromirror angle (via an angle sensor), (2) estimate the unknown vibration using data-driven equations, (3) calculate a vibration compensator output using data-driven equations, (4) add the calculated vibration compensator output to a signal driving the micromirror. This solution is more cost effective than the conventional solutions as it does not require specific hardware redesigns or additional sensor(s) for vibration measurement. It will be appreciated, however, that the MEMS micromirrors could still include anti-vibration hardware features, but the control techniques of the present application are still able to further reduce vibrations via software-based controls.

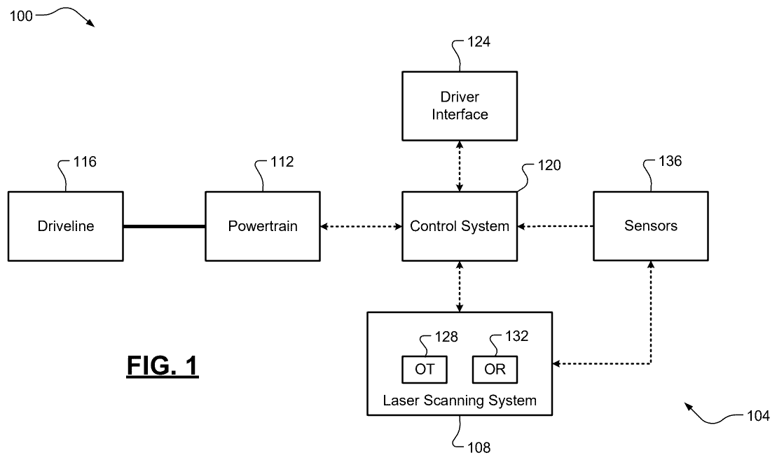

Referring now to FIG. 1, a functional block diagram of a vehicle 100 having a laser scanning system 108 and an example vibration compensation system 104 therefor according to the principles of the present application is illustrated. The vehicle 100 could be any suitable type of vehicle, including automobiles (engine-only automobiles, hybrid automobiles, electric-only automobiles, etc.) as well as other types of vehicles (aerospace, rail, marine, etc.). In an automobile configuration as shown, the vehicle 100 generally comprises a powertrain 112 (an engine, an electric motor, or any combination thereof) configured to generate and transfer drive torque to a driveline 116 for propulsion. The powertrain 112 is controlled by a control system 120 comprising one or more electronic control units (ECUs). Primarily, the control system 120 controls the powertrain 112 to generate a desired amount of drive torque to satisfy a driver torque request received from a driver of the vehicle 100 via a driver interface 124 (e.g., an accelerator pedal).

The control system 120 is also configured to control the laser scanning system 108, although it will be appreciated that the laser scanning system 108 could include its own internal ECU or control system. Non-limiting examples of the laser scanning system 108 include a light detection and ranging (LIDAR) system and a heads-up display (HUD) system. The laser scanning system 108 operates by projecting a beam of light that is reflected off of an optical transmitter (OT) 128 (e.g., a MEMS micromirror system) towards a target (e.g., another vehicle), and, in some applications (e.g., LIDAR), then receiving or collecting reflected light beams at an optical receiver (OR) 132. Internal or separate sensors 136 are also configured to measure parameters such as the deflection angle.

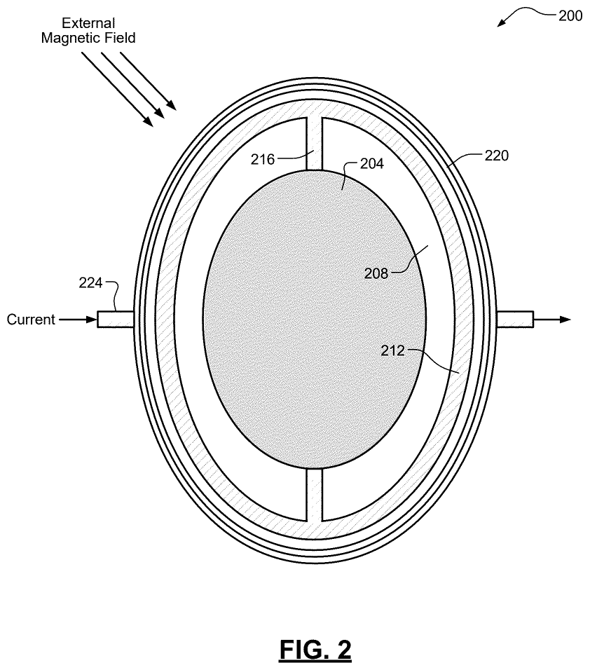

Referring now to FIG. 2 and with continued reference to FIG. 1, a schematic diagram of an example MEMS micromirror 200 for the optical transmitter 128 of the laser scanning system 108 according to the principles of the present application is illustrated. It will be appreciated that this is merely one example configuration of a MEMS micromirror for the optical transmitter 128 and that other suitable configurations could be utilized, including, but not limited to, an array of multiple MEMS micromirrors. As previously mentioned, the optical transmitter 128 is configured to generate and reflect a light beam towards a target (e.g., another vehicle). The optical transmitter 128 typically includes a light source (e.g., a laser), a lens (e.g., a collimation lens), and a reflector, such as the MEMS micromirror 200. The optical receiver 132 typically includes a lens (e.g., a receiving lens) and a photosensitive amplifier. For example, differences between the projected and reflected light beams could then analyzed to determine various parameters (such as a distance between vehicles, vehicle speed, vehicle acceleration, etc.).

As shown, the example MEMS micromirror 200 includes a mirror plate 204 that is rotatable or deflectable within a space 208 further defined by an outer frame 212. The deflection mechanisms for the mirror plate 204 include a fast axis 216 (via a constant magnetic field from a permanent magnet that affects an outer coil 220) and a slow axis 224 (via a current flowing therethrough) for control of the mirror plate 204. The fast axis 216 is performing a fast scanning (e.g., from −60° to 60° in the x-direction) and the slow axis 224 is performing a slow scanning (e.g., from −30° to 30° in the y-direction). Usually, the fast axis 216 only responds to a fixed control frequency signal, which means the scanning pattern of the x-axis is fixed to this control signal and is open-loop controlled. The vibration compensator is not meant to adjust this scanning pattern. For the slowing scanning axis 224, the scanning is controlled by a slow change signal, which means the scanning pattern can be adjusted based on the measured deflection angle. The angle control on the slow axis is a closed-loop control. The control signal uₖ that is compensated by the vibration compensator is targeted for this y-axis angle scanning control. The angle at which the mirror plate 204 is deflected is called a deflection angle. Thus, the MEMS micromirror system 200 is operable by controlling the magnetic field and/or current acting thereupon to deflect or displace the deflection mechanism and thereby achieve a desired deflection angle.

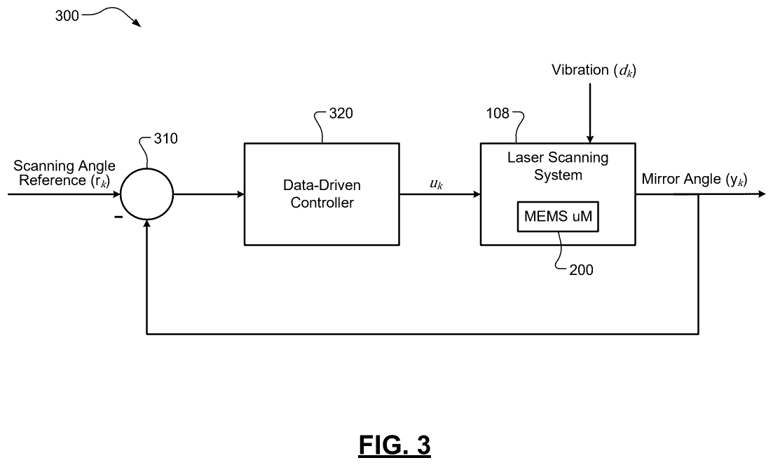

Referring now to FIG. 3 and with continued reference to the previous figures, a functional block diagram of an example system architecture 300 for the vibration compensation system 104 according to the principles of the present application is illustrated. As shown, an unknown external vibration (dₖ) affects the laser scanning system 108 and, more specifically, a deflection or mirror angle (yₖ) of the MEMs micromirror (uM) 200. A scanning angle reference (ηₖ) has the mirror yₖ subtracted therefrom at 310 and the error signal (i.e., the difference) is fed to a data-driven controller 320. The data-driven controller 320 establishes and utilizes a data-driven or physics-based model to estimate the vibration dₖ and determine a modified or compensated input voltage signal (uₖ), which compensates for the vibration dₖ, and is then provided to the laser scanning system 108 to control the MEMS micromirror (uM) 200. The specific data-driven process executed by the data-driven controller 320 will now be described in greater detail.

The MEMS micromirror 200 can be modeled using a physics based first-principle model or by a data-driven generic model. In this example, the following data driven model is applied as a more generic example:

$${y}_{k} = [ 1 - A ( {q}^{- 1} ) ] {y}_{k} + B ( {q}^{- 1} ) h ( {u}_{k - 1} ) , \qquad ( 1 )$$

where k is an index of the sample, q⁻¹ is a unit back shift operator, yₖ is the deflection angle of the mirror plate 204, uₖ is the input driving voltage signal, h(uₖ₋₁) is an output torque of the driving mechanism, A(q⁻¹) and B(q⁻¹) are model parameter polynomials, such as:

$$A ( {q}^{- 1} ) = 1 + {a}_{1} {q}^{- 1} + … {a}_{n} {q}^{- n} and ,$$

$$B ( {q}^{- 1} ) = {b}_{0} + {b}_{1} {q}^{- 1} + … {b}_{m} {q}^{- m} ,$$

and their values could be identified using any suitable method. Suppose also that h(uₖ₋₁) is a Lipschitz continuous function, i.e., there exists Kₕ≥0 such that:

$$\vert h ( {u}_{k} ) - h ( {u}_{k - 1} ) \vert \leq {K}_{h} \vert {u}_{k} - {u}_{k - 1} \vert .$$

By using known system identification techniques, the parameters of the model of Equation (1) can be estimated. Thus, we obtain:

$${\hat{y}}_{k} = [ 1 - Â ( {q}^{- 1} ) ] {\hat{y}}_{k} + \hat{B} ( {q}^{- 1} ) \hat{h} ( {u}_{k - 1} ) , \qquad ( 2 )$$

where ŷ, ĥ, Â and \hat{B} are the model output, an estimated hysteresis sub-model, and an estimation of polynomials of the model, respectively. In Equation (2), we can let ŷₖ₋₁=yₖ₋ᵢ when i≥0. Thus, considering the impact of the unknown external vibration dₖ being exerted on the system, the real system is as follows:

$${y}_{k} = [ 1 - A ( {q}^{- 1} ) ] {y}_{k} + B ( {q}^{- 1} ) h ( {u}_{k - 1} ) + {d}_{k} , \qquad ( 3 )$$

where the vibration dₖ is assumed to have an upper bound, i.e., for Dₘ>0, |dₖ|≤Dₘ. Next, we assume that the unknown vibration dₖ can be estimated by the following:

$$C ( {e}_{k} ) = {\overline{η}}_{k} + {d}_{k} , \qquad ( 4 )$$

where C(eₖ) is an estimator function for the vibration dₖ, and where eₖ=yₖ− [symbol] and η̅ₖ represents an uncertainty of the model, where:

$${\overline{η}}_{k} = C \{ [ Â ( {q}^{- 1} ) - A ( {q}^{- 1} ) ] {y}_{k} + [ B ( {q}^{- 1} ) h ( {u}_{k - 1} ) - \hat{B} ( {q}^{- 1} ) \hat{h} ( {u}_{k - 1} ) ] \} . \qquad ( 5 )$$

If the model is very accurate, we can assume that this model uncertainty η̅ₖ is very low (e.g., equal to zero). Thus, the upper bound of this uncertainty value η̅ₖ is significantly lower than the upper bound of the unknown vibration dₖ (i.e., if | [symbol] |<<dₖ). As a result, C(eₖ)≈dₖ, or, if η̅ₖ equals zero:

$$C ( {e}_{k} ) = {d}_{k} . \qquad ( 6 )$$

In addition, we can assume that C(eₖ) is a Lipschitz continuous function and there exists a Kₑ≥0, such that:

$$\vert C ( {e}_{k} ) - C ( {e}_{k - 1} ) \vert \leq {K}_{e} \vert {e}_{k} - {e}_{k - 1} \vert . \qquad ( 7 )$$

Then, if the below cost function (Q) reached its minimum, it means that ŷₖ is approaching the reference point rₖ and, at the same time, the vibration dₖ is also suppressed to its minimum.

$$Q = \frac{1}{2} {( {r}_{k} - {\hat{y}}_{k} )}^{2} + \frac{{λ}_{c}}{2} {C}^{2} ( {e}_{k} ) , \qquad ( 8 )$$

where rₖ is the reference angle and λ_{c}>0 is an optimizing step size.

Thus, the vibration compensation strategy is derived such that:

$${u}_{k} = arg min Q . \qquad ( 9 )$$

In other words, the control deviation is thus to solve an optimization problem and locate the control input uₖ such that Q reaches its minimum. Thus, Equation (9) becomes:

$${u}_{k} = {u}_{k - 1} - {μ}_{k} {χ}_{k} , \qquad ( 10 )$$

with uₖ₋₁ being the input from the previous cycle and where:

$$\{ \begin{matrix}{μ}_{k} = \frac{1}{{λ}_{c}} ; \\ {χ}_{k} = \frac{\partial Q}{\partial {u}_{k - 1}} = - ( {r}_{k} - {\hat{y}}_{k} ) ( \frac{\partial {\hat{y}}_{k}}{\partial {u}_{k - 1}} ) + {λ}_{c} C ( {e}_{k} ) ( \frac{\partial c ( {e}_{k} )}{\partial {u}_{k - 1}} )\end{matrix} . \qquad ( 11 )$$

In addition, C(eₖ₊₁) is selected as C(eₖ)=βeₖ, which can be assumed given the previous Lipschitz continuous function assumption, and λ_{c} and β are tuning parameters that can be adjusted during the optimization. All of the other parameters can be directly derived from either direct measurement or from model calculation.

Now, in application, the data-driven controller 320 utilizes Equations (4)-(6) to estimate the unknown vibration dₖ. Next, the data-driven controller 320 utilizes Equations (10)-(12) to determine a vibration compensation for the input driving voltage signal uₖ. This determined vibration compensation can be added to the input driving voltage signal uₖ to obtain a modified or compensated input driving voltage signal, which is then output to the laser scanning system 108 for use in controlling the deflection angle of the MEMS micromirror 200 to compensate for the vibration. This process can continue for a plurality of samples (k=1 . . . . N, where N is an integer greater than or equal to one) of the deflection or mirror angle yₖ from a respective sensor 136. The online determination and usage of the modified or compensated input driving voltage signal uₖ is able to compensate for the unknown external vibration dₖ without adding additional vibration sensor(s) and without altering a design of the MEMS micromirror 200 (e.g., adding anti-vibration features, such as stiffer hinges).

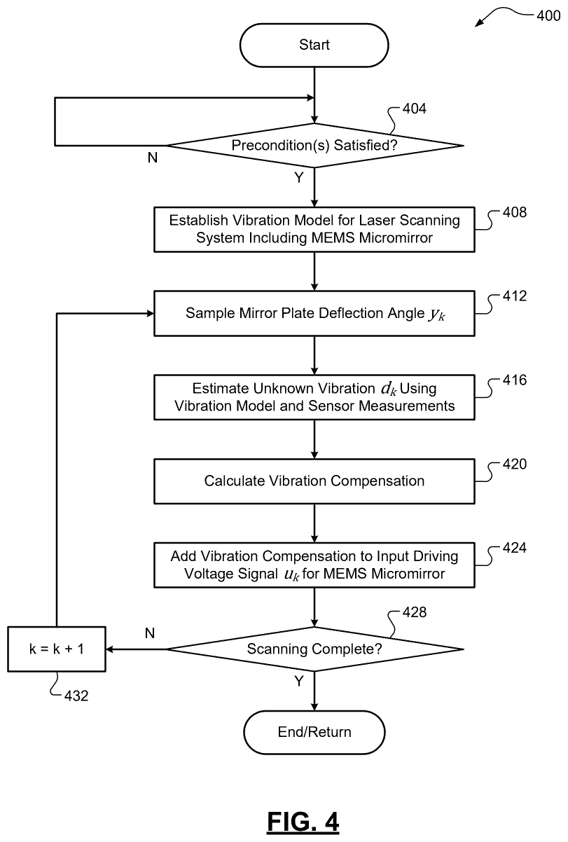

Referring now to FIG. 4 and with continued reference to the previous figures, a flow diagram of an example vibration compensation method 400 for a MEMS micromirror laser scanning system of a vehicle according to the principles of the present application is illustrated. While the vehicle 100 and its components are specifically referenced for descriptive/illustrative purposes, it will be appreciated that the method 400 could be applicable to any suitable MEMS micromirror laser scanning system, including both automotive and non-automotive applications (aerospace, rail, marine, etc.). The method 400 begins at optional 404 where the control system 120 could determine whether an optional set of one or more preconditions are satisfied. This could include, for example, the vehicle 100 being powered up and operational and there being no malfunctions or faults present that would negatively impact or otherwise inhibit the operation of the techniques of the present application. When true, the method 400 proceeds to 408. When false, the method 400 ends or returns to 404.

At 408, the control system 120 establishes (e.g., during production) or obtains/accesses (e.g., on a production vehicle) the vibration model for the laser scanning system 108 including the MEMS micromirror system 200 as previously described herein. At 412, the control system 120 samples a deflection angle yₖ of the mirror plate 204 using a respective sensor 136. At 416, the control system 120 estimates the unknown external vibration dₖ using the vibration model and sensor measurements (e.g., the deflection angle yₖ and the input driving voltage signal uₖ). At 420, the control system 120 calculates a vibration compensation based on the estimate of the vibration dₖ. At 424, the control system 120 adds the vibration compensation to the input driving voltage signal to obtain a modified or compensated input driving voltage signal uₖ, which is then used to control the MEMS micromirror system 200 to compensate for the vibration dₖ. At 428, the control system 120 determines whether a current scanning operation is complete (0-90 degrees, 0-180 degrees, etc.) or, in other words, whether there are any more samples to take. When true, the sample index k is incremented at 432 and the method 400 returns to 412. When false, the method 400 ends.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A vibration compensation system for a laser scanning system of a vehicle, the laser scanning system comprising a micro electromechanical system (MEMS) micromirror, the vibration compensation system comprising:
a sensor configured to measure a deflection angle of a mirror plate of the MEMS micromirror; and
a control system configured to:
establish or access a model for the MEMS micromirror;
determine, using the sensor, a sample of the deflection angle;
estimate, using the model and defection angle sample, a vibration of the MEMS micromirror;
calculate, using the model and the estimated vibration, a vibration compensation;
add the vibration compensation to an input driving voltage signal for a deflection mechanism of the MEMS micromirror to obtain a compensated input driving voltage signal, where the deflection mechanism is configured to control the deflection angle of the mirror plate; and
control the deflection mechanism using the compensated input driving voltage signal to mitigate or eliminate the vibration of the MEMS micromirror.

2. The vibration compensation system of claim 1, wherein the vibration model is based on the following equation:
$${y}_{k} = [ 1 - A ( {q}^{- 1} ) ] {y}_{k} + B ( {q}^{- 1} ) h ( {u}_{k - 1} ) + {d}_{k} ,$$
where k is an index of the sample, q⁻¹ is a unit back shift operator, yₖ is the deflection angle of the mirror plate, uₖ is the input driving voltage signal, h(uₖ₋₁) is an output torque of the driving mechanism, A(q⁻¹) and B(q⁻¹) are polynomials, and dₖ is the vibration.

3. The vibration compensation system of claim 2, wherein the output torque h(uₖ₋₁) is a Lipschitz continuation function:
$$\vert h ( {u}_{k} ) - h ( {u}_{k - 1} ) \vert \leq {K}_{h} \vert {u}_{k} - {u}_{k - 1} \vert ,$$
where there exists Kₕ≥0, and wherein the polynomials are:
$$A ( {q}^{- 1} ) = 1 + {a}_{1} {q}^{- 1} + … {a}_{n} {q}^{- n} , and$$
$$B ( {q}^{- 1} ) = {b}_{0} + {b}_{1} {q}^{- 1} + … {b}_{m} {q}^{- m} ,$$
where a₁ . . . aₙ and b₁ . . . bₘ are polynomial coefficients.

4. The vibration compensation system of claim 2, wherein the vibration dₖ is estimated as follows:
$$C ( {e}_{k} ) = {\overline{η}}_{k} + {d}_{k} ,$$
where C(eₖ) is an estimator function for the vibration dₖ, and where eₖ=yₖ− [symbol] and η̅ₖ represents an uncertainty of the model, where:
$${\overline{η}}_{k} = C \{ [ Â ( {q}^{- 1} ) - A ( {q}^{- 1} ) ] {y}_{k} + [ B ( {q}^{- 1} ) h ( {u}_{k - 1} ) - \hat{B} ( {q}^{- 1} ) \hat{h} ( {u}_{k - 1} ) ] \} = 0.$$

5. The vibration compensation system of claim 4, wherein the estimator function C(eₖ) is a Lipschitz continuous function:
$$\vert C ( {e}_{k} ) - C ( {e}_{k - 1} ) \vert \leq {K}_{e} \vert {e}_{k} - {e}_{k - 1} \vert ,$$
where Kₑ≥0, and wherein a cost function Q of the vibration compensation system is defined as:
$$Q = \frac{1}{2} {( {r}_{k} - {\hat{y}}_{k} )}^{2} + \frac{{λ}_{c}}{2} {C}^{2} ( {e}_{k} ) ,$$
where rₖ is a reference and λ_{c}>0 is an optimizing step size.

6. The vibration compensation system of claim 5, wherein the vibration compensation u(k) is calculated as:
$${u}_{k} = argmin Q = {u}_{k - 1} - {μ}_{k} {χ}_{k} ,$$
where:
$${μ}_{k} = 1 / {λ}_{c} ,$$
$$and$$
$${χ}_{k} = \frac{\partial Q}{\partial {u}_{k - 1}} = - ( {r}_{k} - {\hat{y}}_{k} ) ( \frac{\partial {\hat{y}}_{k}}{\partial {u}_{k - 1}} ) + {λ}_{c} C ( {e}_{k} ) ( \frac{\partial C ( {e}_{k} )}{\partial {u}_{k - 1}} ) ,$$
and C(eₖ+1) is selected as C(eₖ)=βeₖ, where β is a weighting parameter.

7. The vibration compensation system of claim 1, wherein the vibration is caused by a vibration of the vehicle as it traverses an uneven surface.

8. The vibration compensation system of claim 1, wherein the MEMS micromirror does not include any anti-vibration hardware features.

9. The vibration compensation system of claim 1, wherein the laser scanning system is a light detection and ranging (LIDAR) system of the vehicle.

10. The vibration compensation system of claim 1, wherein the laser scanning system is a heads-up display (HUD) system of the vehicle.

11. A vibration compensation method for a laser scanning system of a vehicle, the laser scanning system comprising a micro electromechanical system (MEMS) micromirror, the vibration compensation method comprising:
measuring, by a sensor of the laser scanning system, a deflection angle of a mirror plate of the MEMS micromirror;
establishing or accessing, by a control system of the vehicle, a model for the MEMS micromirror;
determining, by the control system and using the sensor, a sample of the deflection angle;
estimating, by the control system and using the model and defection angle sample, a vibration of the MEMS micromirror;
calculating, by the control system and using the model and the estimated vibration, a vibration compensation;
adding, by the control system, the vibration compensation to an input driving voltage signal for a deflection mechanism of the MEMS micromirror to obtain a compensated input driving voltage signal, where the deflection mechanism is configured to control the deflection angle of the mirror plate; and
controlling, by the control system, the deflection mechanism using the compensated input driving voltage signal to mitigate or eliminate the vibration of the MEMS micromirror.

12. The vibration compensation method of claim 11, wherein the vibration model is based on the following:
$${y}_{k} = [ 1 - A ( {q}^{- 1} ) ] {y}_{k} + B ( {q}^{- 1} ) h ( {u}_{k - 1} ) + {d}_{k} ,$$
where k is an index of the sample, q⁻¹ is a unit back shift operator, yₖ is the deflection angle of the mirror plate, uₖ is the input driving voltage signal, h(uₖ₋₁) is an output torque of the driving mechanism, A(q⁻¹) and B(q⁻¹) are polynomials, and dₖ is the vibration.

13. The vibration compensation method of claim 12, wherein the output torque h(uₖ₋₁) is a Lipschitz continuation function:
$$\vert h ( {u}_{k} ) - h ( {u}_{k - 1} ) \vert \leq {K}_{h} \vert {u}_{k} - {u}_{k - 1} \vert ,$$
where there exists Kₕ≥0, and wherein the polynomials are:
$$A ( {q}^{- 1} ) = 1 + {a}_{1} {q}^{- 1} + … {a}_{n} {q}^{- n} ,$$
$$and$$
$$B ( {q}^{- 1} ) = {b}_{0} + {b}_{1} {q}^{- 1} + … {b}_{m} {q}^{- m} ,$$
where a₁ . . . aₙ and b₁ . . . bₘ are polynomial coefficients.

14. The vibration compensation method of claim 12, wherein the vibration dₖ is estimated as follows:
$$C ( {e}_{k} ) = {\overline{η}}_{k} + {d}_{k} ,$$
where C(eₖ) is an estimator function for the vibration dₖ, and where eₖ=yₖ− [symbol] and η̅ₖ represents an uncertainty of the model, where:
$${\overline{η}}_{k} = C \{ [ Â ( {q}^{- 1} ) - A ( {q}^{- 1} ) ] {y}_{k} + [ B ( {q}^{- 1} ) h ( {u}_{k - 1} ) - \hat{B} ( {q}^{- 1} ) \hat{h} ( {u}_{k - 1} ) ] \} = 0.$$

15. The vibration compensation method of claim 14, wherein the estimator function C(eₖ) is a Lipschitz continuous function:
$$\vert C ( {e}_{k} ) - C ( {e}_{k - 1} ) \vert \leq {K}_{e} \vert {e}_{k} - {e}_{k - 1} \vert ,$$
where Kₑ≥0, and wherein a cost function Q of the vibration compensation system is defined as:
$$Q = \frac{1}{2} {( {r}_{k} - {\hat{y}}_{k} )}^{2} + \frac{{λ}_{c}}{2} {C}^{2} ( {e}_{k} ) ,$$
where rₖ is a reference and λ_{c}>0 is an optimizing step size.

16. The vibration compensation method of claim 15, wherein the vibration compensation u(k) is calculated as:
$${u}_{k} = argmin Q = {u}_{k - 1} - {μ}_{k} {χ}_{k} ,$$
where:
$${μ}_{k} = 1 / {λ}_{c} ,$$
$$and$$
$${χ}_{k} = \frac{\partial Q}{\partial {u}_{k - 1}} = - ( {r}_{k} - {\hat{y}}_{k} ) ( \frac{\partial {\hat{y}}_{k}}{\partial {u}_{k - 1}} ) + {λ}_{c} C ( {e}_{k} ) ( \frac{\partial C ( {e}_{k} )}{\partial {u}_{k - 1}} ) ,$$
and C(eₖ+1) is selected as C(eₖ)=βeₖ, where β is a weighting parameter.

17. The vibration compensation method of claim 11, wherein the vibration is caused by a vibration of the vehicle as it traverses aₙ uneven surface.

18. The vibration compensation method of claim 11, wherein the MEMS micromirror does not include any anti-vibration hardware features.

19. The vibration compensation method of claim 11, wherein the laser scanning system is a light detection and ranging (LIDAR) system of the vehicle.

20. The vibration compensation method of claim 11, wherein the laser scanning system is a heads-up display (HUD) system of the vehicle.
